(19) United States
(12) Patent Application Publication
(10) Pub. No.: US 2026/0321600 A1
(43) Pub. Date: Oct. 15, 2026

(54) NEGATIVE ELECTRODE PLATE, SECONDARY BATTERY, AND ELECTRONIC APPARATUS

(71) Applicant: Ningde Amperex Technology Limited, Ningde (CN)

(72) Inventors: Wanlin LI, Ningde (CN); Xia LONG, Ningde (CN)

(73) Assignee: Ningde Amperex Technology Limited, Ningde (CN)

(21) Appl. No.: 19/630,454

(22) Filed: Mar. 27, 2026

(30) Foreign Application Priority Data
Apr. 10, 2025 (CN) 202510449619.9

(51) Int. Cl. H01M 4/36; H01M 4/02; H01M 4/38; H01M 4/485; H01M 4/583; H01M 4/66

(52) U.S. Cl. CPC H01M 4/366; H01M 4/386; H01M 4/485; H01M 4/583; H01M 4/661; H01M 2004/021; H01M 2004/027

(57) ABSTRACT

A negative electrode plate includes a negative electrode current collector and a negative electrode active material layer disposed on at least one surface of the negative electrode current collector. The negative electrode active material layer includes a first material layer and a second material layer. The first material layer is disposed between the negative electrode current collector and the second material layer. The second material layer contains the silicon element. The first material layer includes lithium titanate and a first active material. The first active material includes a first silicon-containing material. based on a mass of the negative electrode active material layer, a mass percentage of the lithium titanate is W₁, and 1.5%≤W₁≤2.5%; based on a mass of the negative electrode active material layer, a mass percentage of the silicon element in the first active material is W₂, and 1.5≤W₂/W₁≤4.0.

### CROSS-REFERENCE TO RELATED APPLICATION

This application claims priority to Chinese Patent Application No. 202510449619.9, filed on Apr. 10, 2025, the whole disclosure of which is incorporated herein by reference.

### TECHNICAL FIELD

This application relates to the field of electrochemical technology, and in particular, to a negative electrode plate, a secondary battery, and an electronic apparatus.

### BACKGROUND

With the popularity and upgrading of consumer electronic products such as smartphones, notebook computers, and smart homes, the market demand for consumer lithium-ion batteries continues to grow. Due to the diversified development of electronic products, the requirements for lithium-ion batteries are also increasing, and lithium-ion batteries have also been developed greatly. Silicon-containing materials as negative electrode materials for lithium-ion batteries have high energy density and high theoretical specific capacity compared to conventional graphite negative electrodes. However, silicon-containing materials have large volume changes during the cycling process of lithium-ion batteries. Affected by the alternating expansion stress of silicon-containing material particles, the negative electrode current collector is prone to elongation along the length and width directions, leading to purple spots at the head and tail of the negative electrode plate and piercing of the outer package, thus causing safety issues.

In order to overcome the above issues, in the prior art, lithium titanate is usually applied on the surface of the negative electrode current collector to alleviate its elongation. However, due to the high amount of lithium titanate required, the lithium-ion battery suffers significant energy density loss.

### SUMMARY

This application is intended to provide a negative electrode plate, a secondary battery, and an electronic apparatus, so as to alleviate the energy density loss of the secondary battery and extend its cycle life.

It should be noted that in the summary of this application, an example in which a lithium-ion battery is used as a secondary battery is used to illustrate this application. However, the secondary battery in this application is not limited to the lithium-ion battery. The specific technical solutions are described below.

According to a first aspect of this application, a negative electrode plate is provided. The negative electrode plate includes a negative electrode current collector and a negative electrode active material layer disposed on at least one surface of the negative electrode current collector, where the negative electrode active material layer includes a first material layer and a second material layer, the first material layer is disposed between the negative electrode current collector and the second material layer, and the second material layer contains the silicon element; the first material layer includes lithium titanate and a first active material, and the first active material includes a first silicon-containing material; and based on a mass of the negative electrode active material layer, a mass percentage of the lithium titanate is W₁, a mass percentage of the silicon element in the first active material is W₂, and W₁ and W₂ satisfy: 1.5%≤W₁≤2.5%, and 1.5≤W₂/W₁≤4.0. According to the negative electrode plate provided in the first aspect of this application, the surface of the negative electrode current collector is provided with the first material layer containing the lithium titanate and the first active material and the second material layer containing the silicon element as the negative electrode active material layer; and the mass percentage of the lithium titanate in the negative electrode active material layer and a ratio of the lithium titanate in the negative electrode active material layer to the mass percentage of the silicon element in the first active material are controlled within the ranges of this application. The lithium titanate can effectively alleviate the influence of the alternating expansion stress of silicon-containing material particles on the elongation of the negative electrode current collector along length and width directions (hereinafter referred to as XY elongation), making the XY elongation of the negative electrode current collector small, and reducing the probability of purple spots at the head and tail of the negative electrode plate and electrolyte leakage caused by piercing of an outer package. This also makes a total addition amount of the lithium titanate in the negative electrode plate small. In this application, the addition of the first active material including the first silicon-containing material in the first material layer is conducive to increasing the capacity of the first material layer, thereby reducing the energy density loss of a secondary battery caused by the lithium titanate when the negative electrode plate is applied to the secondary battery. The silicon-containing material in the negative electrode active material layer continuously expands and contracts during charge and discharge cycles of the secondary battery, reducing the contact tightness between the silicon-containing material particles. Poor contact between particles of the first active material in the first material layer and the negative electrode current collector easily causes lithium ion conduction inactivation, leading to accelerated capacity decay of the secondary battery. In this application, blending the lithium titanate with the first active material can play a role of “filling gaps” between the particles of the first active material. The lithium titanate forms bridges between the inactivated particles of the first active material, improving the electrical contact between the particles of the first active material in the first material layer. In this way, when the negative electrode plate is applied to the secondary battery, the problem of “lithium ion conduction inactivation” faced by the secondary battery during the charge and discharge cycles can be alleviated, slowing down the capacity decay of the secondary battery, thereby extending the cycle life of the secondary battery. Thus, when the negative electrode plate according to the first aspect of this application is applied to a silicon-based secondary battery, the energy density loss of the secondary battery can be alleviated, and the cycle life of the secondary battery can be extended, alleviating the purple spots at the head and tail of the negative electrode plate, and allowing the secondary battery to have good kinetic performance.

In some embodiments of this application, the lithium titanate has a particle size Dᵥ10 of D₁₁, a particle size Dᵥ50 of D₁₂, and a particle size Dᵥ90 of D₁₃, where 0.3 μm≤D₁₁≤0.4 μm, 0.7 μm≤D₁₂≤1.0 μm, and 1.1 μm≤D₁₃≤1.5 μm. Controlling the particle size Dᵥ10, the particle size Dᵥ50, and the particle size Dᵥ90 of the lithium titanate within the above ranges is conducive to the distribution of lithium titanate particles in gaps formed by particles of other substances in the first material layer, which is conducive to improving the electrical contact between active material particles in the first material layer.

In some embodiments of this application, the first active material has a particle size Dᵥ10 of D₂₁, a particle size Dᵥ50 of D₂₂, and a particle size Dᵥ90 of D₂₃;

and the particle sizes of the lithium titanate and the particle sizes of the first active material satisfy: 8.0≤D₂₁/D₁₁≤12.0, 7.3≤D₂₂/D₁₂≤10.4, and 8.6≤D₂₃/D₁₃≤11.8. Controlling the values of D₂₁/D₁₁, D₂₂/D₁₂ and D₂₃/D₁₃ within the above ranges alleviates the energy density loss of the secondary battery using the negative electrode plate, further extends the cycle life of the secondary battery, and is also conducive to alleviating the purple spots at the head and tail of the negative electrode plate, thereby allowing the secondary battery to have good kinetic performance.

In some embodiments of this application, a single-layer thickness of the first material layer is T₁, and 10 μm≤T₁≤12 μm. Controlling the single-layer thickness of the first material layer within the above range and reducing the total addition amount of the lithium titanate in the negative electrode plate allow the secondary battery to have a high energy density on the basis of having a long cycle life.

In some embodiments of this application, a total thickness of the negative electrode active material layer is T₂, and 12%≤T₁/T₂×100%≤37%. Controlling the value of T₁/T₂×100% within the above range allows the secondary battery to have a high energy density on the basis of having a long cycle life.

In some embodiments of this application, the negative electrode plate satisfies at least one of the following features: (1) based on the mass of the negative electrode active material layer, a mass percentage of the silicon element in the negative electrode active material layer is W₃, and 3.5%≤W₃≤30%; or (2) 2.4≤W₂/W₁≤4.0. This is conducive to allowing the negative electrode plate to have a high capacity and allowing the secondary battery using the negative electrode plate to have a high energy density and a long cycle life.

In some embodiments of this application, a specific surface area of the lithium titanate is 3.1 m²/g to 8.2 m²/g. Controlling the specific surface area of the lithium titanate within the above range can increase the lithium intercalation and deintercalation capacity of the lithium titanate and reduce the solid-phase transmission impedance, improving the capacity and rate performance of the secondary battery.

In some embodiments of this application, a powder conductivity of the lithium titanate is 10⁻⁶ S/m to 10⁻⁴ S/m. Controlling the powder conductivity of the lithium titanate within the above range is conducive to improving the rate performance, cycling stability, fast charging performance, and mechanical stability of the secondary battery, and also helps to improve the first-cycle coulombic efficiency.

In some embodiments of this application, the lithium titanate satisfies at least one of the following features: (1) a specific surface area of the lithium titanate is 4.2 m²/g to 8.2 m²/g; or (2) a powder conductivity of the lithium titanate is 4×10⁻⁵ S/m to 6×10⁻⁵ S/m.

In some embodiments of this application, the second material layer includes a second active material, where the second active material includes a second silicon-containing material, and the second silicon-containing material includes at least one of a silicon-carbon compound, a silicon-oxygen compound, or pure silicon. The above types of second silicon-containing materials have high energy densities and theoretical specific capacities, and selecting the above types of second silicon-containing materials is conducive to allowing the negative electrode plate to have a high capacity. In some embodiments of this application, the negative electrode current

collector includes any one of a copper current collector, a foamed copper current collector, a nickel current collector, or a stainless steel current collector. Selecting the above types of negative electrode current collectors is conducive to allowing the secondary battery to have good kinetic performance, a high energy density, and a long cycle life.

According to a second aspect of this application, a secondary battery is provided and includes the negative electrode plate according to any one of the foregoing embodiments. Therefore, the secondary battery has good kinetic performance, a high energy density, and a long cycle life.

According to a third aspect of this application, an electronic apparatus is provided and includes the secondary battery according to any one of the foregoing embodiments. Therefore, the electronic apparatus has good use performance.

The beneficial effects of this application are described below.

This application provides a negative electrode plate, a secondary battery, and an electronic apparatus. The negative electrode plate includes a negative electrode current collector and a negative electrode active material layer disposed on at least one surface of the negative electrode current collector. The negative electrode active material layer includes a first material layer and a second material layer. The first material layer is disposed between the negative electrode current collector and the second material layer. The second material layer contains the silicon element. The first material layer includes lithium titanate and a first active material. The first active material includes a first silicon-containing material. Based on a mass of the negative electrode active material layer, a mass percentage of the lithium titanate is W₁, a mass percentage of the silicon element in the first active material is W₂, and W₁ and W₂ satisfy: 1.5%≤W₁≤2.5%, and 1.5≤W₂/W₁≤4.0. Through the above setting, the lithium titanate can effectively alleviate the influence of the alternating expansion stress of silicon-containing material particles on the XY elongation of the negative electrode current collector, making the XY elongation of the negative electrode current collector small, and reducing the probability of purple spots at the head and tail of the negative electrode plate and electrolyte leakage caused by piercing of an outer package. This also makes a total addition amount of lithium titanate in the negative electrode plate small, thereby reducing the energy density loss of the secondary battery caused by lithium titanate when the negative electrode plate is applied to the secondary battery. Blending the lithium titanate with the first active material can play a role of “filling gaps” between large-particle materials, improving the electrical contact between active material particles in the first material layer. When the negative electrode plate is applied to the secondary battery, the problem of “lithium ion conduction inactivation” caused by the expansion of the silicon-containing material during the charge and discharge cycles of the secondary battery, thereby extending the cycle life of the secondary battery, alleviating the purple spots at the head and tail of the negative electrode plate, and allowing the secondary battery to have good kinetic performance.

Certainly, implementing any product or method of this application does not necessarily need to achieve all the advantages described above at the same time.

### BRIEF DESCRIPTION OF DRAWINGS

In order to more clearly illustrate the technical solutions in some embodiments of this application or the prior art, the drawings to be used in the description of these embodiments or the prior art will be briefly introduced below. Apparently, the drawings described below are only some embodiments of this application. For those of ordinary skill in the art, other drawings can also be obtained based on these drawings.

FIG. 1 is a schematic cross-sectional structural diagram of a negative electrode plate according to some embodiments of this application along its thickness direction and length direction.

Reference signs: 100. negative electrode plate; 10. negative electrode current collector; 11. first material layer; 12. second material layer; and 20. negative electrode active material layer.

### DETAILED DESCRIPTION

The technical solutions in this application will be clearly and completely described below in combination with some embodiments of this application and the accompanying drawings. Apparently, the described embodiments are only some rather than all of these embodiments of this application. All other embodiments obtained by those skilled in the art based on this application fall within the protection scope of this application.

It should be noted that in the specific embodiments of this application, an example in which a lithium-ion battery is used as a secondary battery is used to illustrate this application. However, the secondary battery in this application is not limited to the lithium-ion battery.

According to a first aspect of this application, a negative electrode plate is provided. The negative electrode plate includes a negative electrode current collector and a negative electrode active material layer disposed on at least one surface of the negative electrode current collector. The negative electrode active material layer includes a first material layer and a second material layer. The first material layer is disposed between the negative electrode current collector and the second material layer. The second material layer contains the silicon element. The first material layer includes lithium titanate and a first active material. The first active material includes a first silicon-containing material. Based on a mass of the negative electrode active material layer, a mass percentage of the lithium titanate is W₁, a mass percentage of the silicon element in the first active material is W₂, and W₁ and W₂ satisfy: 1.5%≤W₁≤2.5%, and 1.5≤W₂/W₁≤4.0. Further, 2.4≤W₂/W₁≤4.0.

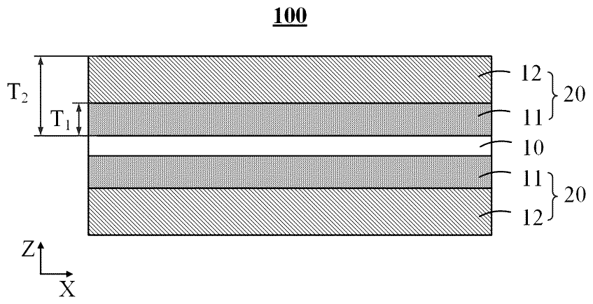

For ease of understanding, in this application, the negative electrode plate has a length direction defined as X and a thickness direction defined as Z. It should be understood that the above definition of directions is for the purpose of facilitating the description of this application, and the directions defined in this application can be understood according to the relative positions of the elements in the drawings and the actual product. Moreover, length directions and thickness directions of the negative electrode current collector, the first material layer and the second material layer are the same as those of the negative electrode plate. The above “a negative electrode active material layer disposed on at least one surface of the negative electrode current collector” means that the negative electrode active material layer is disposed on one surface or two surfaces of the negative electrode current collector. The above “surface” may be a partial surface of the negative electrode current collector or an entire surface of the negative electrode current collector. As shown in FIG. 1, a negative electrode plate 100 includes a negative electrode current collector 10 and a negative electrode active material layer 20. The negative electrode active material layer 20 is disposed on two surfaces of the negative electrode current collector 10. The negative electrode active material layer 20 includes a first material layer 11 and a second material layer 12.

The first material layer 11 is disposed between the negative electrode current collector 10 and the second material layer 12. Certainly, it can be understood that in some embodiments of this application, the negative electrode active material layer 20 is disposed on one surface of the negative electrode current collector 10.

For example, W₁ is 1.5%, 1.6%, 1.7%, 1.8%, 1.9%, 2.0%, 2.1%, 2.2%, 2.3%, 2.4%, 2.5%, or any value in a range defined by any two of the above values. A spinel structure of the lithium titanate (abbreviated as LTO with a chemical formula Li₄Ti₅O₁₂) has very small changes of less than 1% in lattice constant and volume during intercalation or deintercalation of lithium ions. This “zero strain” can avoid structural damage caused by the back-and-forth expansion and contraction of an electrode material. When the lithium titanate is applied on the surface of the negative electrode current collector, the alternating expansion stress of silicon-containing material particles on the negative electrode current collector during the charge and discharge process of a secondary battery can be reduced, the problems of purple spots at the head and tail of a negative electrode plate interface caused by the elongation of the negative electrode current collector along length and width directions (hereinafter referred to as XY elongation) can be reduced, and the probability of safety problems caused by electrolyte leakage due to piercing of an outer package during the XY elongation of the negative electrode current collector can also be reduced. However, a gram capacity of the lithium titanate is lower than a gram capacity of a conventional carbon active material, and a discharge voltage plateau of the lithium titanate to lithium is approximately 1.6 V. Corresponding to a full battery voltage of approximately 2.3 V, this voltage is outside a usage voltage range (3 V to 4.45 V) of a current conventional lithium cobaltate secondary battery, so the use of the lithium titanate causes the volume energy density (VED) loss of the secondary battery. When W₁ is less than 1.5%, the mass percentage of the lithium titanate is excessively low, and the improvement effect of the lithium titanate on the ductility of the negative electrode current collector is not obvious. When W₁ is greater than 2.5%, the mass percentage of the lithium titanate is excessively high, which causes excessive volume energy density loss of the secondary battery.

For example, the value of W₂/W₁ is 1.5, 1.7, 1.8, 2.0, 2.2, 2.4, 2.5, 2.7, 2.8, 3.0, 3.2, 3.3, 3.6, 3.7, 3.8, 4.0, or any value in a range defined by any two of the above values. More silicon-containing material particles on the surface of the negative electrode current collector lead to greater XY elongation of the negative electrode current collector caused by the influence of the alternating expansion stress of the silicon-containing material particles on the negative electrode current collector. The introduction of the lithium titanate can alleviate the influence of the alternating expansion stress of the silicon-containing material particles on the XY elongation of the negative electrode current collector. The inventors have found through research that when the value of W₂/W₁ is less than 1.5, the amount of the lithium titanate is excessively large relative to the amount of the silicon-containing material, and the introduction of excess lithium titanate leads to a decrease in the percentage of the negative electrode active material and also causes the volume energy density loss of the secondary battery, thereby leading to a decreased volume energy density and a shortened cycle life of the secondary battery. When the value of W₂/W₁ is greater than 4.0, the amount of the lithium titanate is excessively small relative to the amount of the silicon-containing material, and the alleviation of the lithium titanate on the XY elongation of the negative electrode current collector is far from enough to offset the influence of the alternating expansion stress of the silicon-containing material particles on the negative electrode current collector.

Overall, according to the negative electrode plate provided in the first aspect of this application, the surface of the negative electrode current collector is provided with the first material layer containing the lithium titanate and the first active material and the second material layer containing the silicon element as the negative electrode active material layer; and the mass percentage of the lithium titanate in the negative electrode active material layer and a ratio of the lithium titanate in the negative electrode active material layer to the mass percentage of the silicon element in the first active material are controlled within the ranges of this application. The lithium titanate can effectively alleviate the influence of the alternating expansion stress of the silicon-containing material particles on the XY elongation of the negative electrode current collector, making the XY elongation of the negative electrode current collector small, and reducing the probability of purple spots at the head and tail of the negative electrode plate and electrolyte leakage caused by piercing of an outer package. This also makes a total addition amount of the lithium titanate in the negative electrode plate small. In this application, the addition of the first active material including the first silicon-containing material in the first material layer of this application is conducive to increasing the capacity of the first material layer, thereby reducing the energy density loss of the secondary battery caused by the lithium titanate when the negative electrode plate is applied to the secondary battery. The silicon-containing material in the negative electrode active material layer continuously expands and contracts during the charge and discharge cycles of the secondary battery, reducing the contact tightness between the silicon-containing material particles. Poor contact between particles of the first active material in the first material layer and the negative electrode current collector causes lithium ion conduction inactivation, leading to accelerated capacity decay of the secondary battery. The lithium titanate has good electronic conductivity. In this application, blending the lithium titanate with the first active material can play a role of “filling gaps” between the particles of the first active material. The lithium titanate forms bridges between the inactivated particles of the first active material, improving the electrical contact between the particles of the first active material in the first material layer. In this way, when the negative electrode plate is applied to a silicon-based secondary battery, the problem of “lithium ion conduction inactivation” faced by the secondary battery during the charge and discharge cycles can be alleviated, slowing down the capacity decay of the secondary battery, thereby extending the cycle life of the secondary battery. Thus, when the negative electrode plate according to the first aspect of this application is applied to the secondary battery, the energy density loss of the secondary battery can be alleviated, and the cycle life of the secondary battery can be extended, alleviating the purple spots at the head and tail of the negative electrode plate, and allowing the secondary battery to have good kinetic performance.

This application has no particular limitation on the type of the first silicon-containing material, provided that the objectives of this application can be achieved. For example, the first silicon-containing material includes but is not limited to at least one of a silicon-carbon compound, a silicon-oxygen compound, or pure silicon. In some embodiments of this application, the second material layer includes a second active material, where the second active material includes a second silicon-containing material, and the second silicon-containing material includes at least one of a silicon-carbon compound, a silicon-oxygen compound, or pure silicon. The above types of first silicon-containing materials and second silicon-containing materials have high energy densities and theoretical specific capacities, and selecting the above types of silicon-containing materials is conducive to allowing the negative electrode plate to have a high capacity. In this application, the silicon-carbon compound is a silicon-carbon composite material. Based on a mass of the silicon-carbon composite material, a mass percentage of the silicon element is 30% to 70%, and a mass percentage of the carbon element is 30% to 70%. This application has no particular limitation on the silicon-carbon composite material, provided that the objectives of this application can be achieved. For example, the silicon-carbon composite material may be a composite material obtained by deposition. Exemplarily, the silicon-carbon composite material may be a silicon material deposited on a carbon skeleton or a carbon material deposited on a silicon skeleton. The silicon-oxygen compound includes SiOₓ, where 0<x<2. Exemplarily, the silicon-oxygen compound may include silicon monoxide (SiO, where a molar ratio of silicon to oxygen is 1:1). It can be understood that the “silicon-containing material” in this application may be a first silicon-containing material, a second silicon-containing material, or both a first silicon-containing material and a second silicon-containing material. In this application, the first silicon-containing material and the second silicon-containing material may be the same or different.

This application has no particular limitation on the mass percentage W₂ of the silicon element in the first active material, provided that the objectives of this application can be achieved. For example, based on the mass of the negative electrode active material layer, the mass percentage W₂ of the silicon element in the first active material is 2.25% to 10%.

This application has no particular limitation on a control method of the mass percentage of the silicon element in the first active material, provided that the objectives of this application can be achieved. For example, the mass percentage of the silicon element in the first active material can be controlled by controlling the percentage of the first active material in the negative electrode active material layer or controlling the type of the first active material.

It can be understood that in some embodiments of this application, the first material layer includes lithium titanate, a first active material, and a carbon material. In some embodiments of this application, the second active material includes a second silicon-containing material and a carbon material. This application has no particular limitation on the type of the carbon material, provided that the objectives of this application can be achieved. For example, the carbon material includes but is not limited to at least one of artificial graphite, natural graphite, hard carbon, soft carbon, or mesophase carbon microspheres.

In some embodiments of this application, the lithium titanate has a particle size Dᵥ10 of D₁₁, a particle size Dᵥ50 of D₁₂, and a particle size Dᵥ90 of D₁₃, where 0.3 μm≤D₁₁≤0.4 μm, 0.7 μm≤D₁₂≤1.0 μm, and 1.1 μm≤D₁₃≤1.5 μm. For example, D₁₁ is 0.3 μm, 0.31 μm, 0.32 μm, 0.33 μm, 0.34 μm, 0.35 μm, 0.36 μm, 0.37 μm, 0.38 μm, 0.39 μm, 0.4 μm, or any value in a range defined by any two of the above values. For example, D₁₂ is 0.7 μm, 0.71 μm, 0.74 μm, 0.76 μm, 0.78 μm, 0.8 μm, 0.82 μm, 0.87 μm, 0.9 μm, 0.93 μm, 1.0 μm, or any value in a range defined by any two of the above values. For example, D₁₃ is 1.1 μm, 1.15 μm, 1.2 μm, 1.23 μm, 1.27 μm, 1.3 μm, 1.32 μm, 1.37 μm, 1.4 μm, 1.45 μm, 1.5 μm, or any value in a range defined by any two of the above values. Controlling the particle size Dᵥ10, the particle size Dᵥ50, and the particle size Dᵥ90 of the lithium titanate within the above ranges is conducive to the distribution of lithium titanate particles in gaps formed by particles of other substances in the first material layer, which is conducive to improving the electrical contact between active material particles in the first material layer. In this way, applying the negative electrode plate to the secondary battery is conducive to allowing the secondary battery to have a high energy density and further alleviating the problem of “lithium ion conduction inactivation” faced by the secondary battery during the charge and discharge cycles, thereby further extending the cycle life of the secondary battery. This is also conducive to alleviating the purple spots at the head and tail of the negative electrode plate, allowing the secondary battery to have good kinetic performance.

In some embodiments of this application, the first active material has a particle size Dᵥ10 of D₂₁, a particle size Dᵥ50 of D₂₂, and a particle size Dᵥ90 of D₂₃; and the particle sizes of the lithium titanate and the particle sizes of the first active material satisfy: 8.0≤D₂₁/D₁₁≤12.0, 7.3≤D₂₂/D₁₂≤10.4, and 8.6≤D₂₃/D₁₃≤11.8. For example, the value of D₂₁/D₁₁ is 8.0, 8.3, 8.7, 9.0, 9.2, 9.6, 10.0, 10.5, 11.0, 11.3, 11.6, 12.0, or any value in a range defined by any two of the above values. For example, the value of D₂₂/D₁₂ is 7.3, 7.4, 7.7, 8.0, 8.3, 8.6, 9.0, 9.6, 9.8, 10.0, 10.4, or any value in a range defined by any two of the above values. For example, the value of D₂₃/D₁₃ is 8.6, 8.8, 9.0, 9.3, 9.7, 10.0, 10.4, 10.6, 11.0, 11.5, 11.8, or any value in a range defined by any two of the above values. The values of D₂₁/D₁₁, D₂₂/D₁₂ and D₂₃/D₁₃ are controlled within the above ranges. The lithium titanate has a smaller particle size compared to the first active material. Small-particle lithium titanate is blended with the large-particle first active material, so that the small-particle lithium titanate fully fills gaps formed by particles of the large-particle first active material, which can play a role of “filling gaps” of small particles between large particles, improving the electrical contact between the particles of the first active material in the first material layer, alleviating the problem of “lithium ion conduction inactivation” faced by the secondary battery using the negative electrode plate during the charge and discharge cycles, and slowing down the capacity decay of the secondary battery, thereby further extending the cycle life of the secondary battery. Thus, the energy density loss of the secondary battery can be alleviated, and the cycle life of the secondary battery can be further extended. This is also conducive to allowing the lithium titanate in the first material layer to alleviate the influence of the alternating expansion stress of the silicon-containing material particles on the XY elongation of the negative electrode current collector, alleviating the purple spots at the head and tail of the negative electrode plate, thereby allowing the secondary battery to have good kinetic performance.

This application has no particular limitation on the particle size Dᵥ10, the particle size Dᵥ50, and the particle size Dᵥ90 of the first active material, provided that the objectives of this application can be achieved. For example, the particle sizes of the first active material satisfy: 2.4 μm≤D₂₁≤4.8 μm, 4.9 μm≤D₂₂≤11 μm, and 9.4 μm≤D₂₃≤18 μm.

In this application, the “particle size Dᵥ10 of the lithium titanate” refers to a particle size at which the cumulative volume reaches 10% from the small particle size side in the volume-based particle size distribution of lithium titanate particles; the “particle size Dᵥ50 of the lithium titanate” refers to a particle size at which the cumulative volume reaches 50% from the small particle size side in the volume-based particle size distribution of lithium titanate particles; and the “particle size Dᵥ90 of lithium titanate” refers to a particle size at which the cumulative volume reaches 90% from the small particle size side in the volume-based particle size distribution of lithium titanate particles. The “particle size Dᵥ10 of the first active material” refers to a particle size at which the cumulative volume reaches 10% from the small particle size side in the volume-based particle size distribution of the first active material particles; the “particle size Dᵥ50 of the first active material” refers to a particle size at which the cumulative volume reaches 50% from the small particle size side in the volume-based particle size distribution of the first active material particles; and the “particle size Dᵥ90 of the first active material” refers to a particle size at which the cumulative volume reaches 90% from the small particle size side in the volume-based particle size distribution of the first active material particles.

In some embodiments of this application, a single-layer thickness of the first material layer is T₁, and 10 μm≤T₁≤12 μm. For example, T₁ is 10 μm, 10.5 μm, 11 μm, 11.6 μm, 12 μm, or any value in a range defined by any two of the above values. Controlling the single-layer thickness of the first material layer within the above range is conducive to reducing the total addition amount of the lithium titanate in the negative electrode plate, thereby reducing the energy density loss of the secondary battery caused by the lithium titanate when the negative electrode plate is applied to the secondary battery. Thus, the secondary battery may have a high energy density on the basis of having a long cycle life. This is also conducive to alleviating the purple spots at the head and tail of the negative electrode plate, allowing the secondary battery to have good kinetic performance. This is also conducive to allowing the lithium titanate in the first material layer to alleviate the influence of the alternating expansion stress of the silicon-containing material particles on the XY elongation of the negative electrode current collector, alleviating the purple spots at the head and tail of the negative electrode plate, thereby allowing the secondary battery to have good kinetic performance.

In some embodiments of this application, a total thickness of the negative electrode active material layer is T₂, and 12%≤T₁/T₂×100%≤37%. For example, the value of T₁/T₂×100% is 12%, 15%, 17%, 20%, 22%, 24%, 27%, 30%, 32%, 37%, or any value in a range defined by any two of the above values. Controlling the value of T₁/T₂×100% within the above range is conducive to reducing the total addition amount of the lithium titanate in the negative electrode plate, thereby reducing the energy density loss of the secondary battery caused by the lithium titanate when the negative electrode plate is applied to the secondary battery. Thus, the secondary battery can have a high energy density on the basis of having a long cycle life.

This application has no particular limitation on the total thickness of the negative electrode active material layer, provided that the objectives of this application can be achieved. For example, the total thickness of the negative electrode active material layer is 25 μm to 110 μm. This application has no particular limitation on the single-layer thickness of the second material layer, provided that the objectives of this application can be achieved. For example, the single-layer thickness of the second material layer is 15 μm to 90 μm.

In some embodiments of this application, based on the mass of the negative electrode active material layer, a mass percentage of the silicon element in the negative electrode active material layer is W₃, and 3.5%≤W₃≤30%. For example, W₃ is 3.5%, 8%, 10%, 12.5%, 15%, 17.6%, 22%, 24%, 26%, 27.7%, 30%, or any value in a range defined by any two of the above values. The active material containing the silicon element has a high energy density and theoretical specific capacity. Controlling the mass percentage of the silicon element in the negative electrode active material layer within the above range is conducive to allowing the negative electrode plate have a high capacity and allowing the secondary battery using the negative electrode plate to have a high energy density and a long cycle life.

This application has no particular limitation on a control method of the mass percentage W₃ of the silicon element in the negative electrode active material layer, provided that the objectives of this application can be achieved. For example, the mass percentage W₃ of the silicon element in the negative electrode active material layer can be controlled by controlling at least one of the addition amount of the first active material in the first material layer or the addition amount of the second silicon-containing material in the second material layer.

In some embodiments of this application, a specific surface area of the lithium titanate is 3.1 m²/g to 8.2 m²/g. For example, the specific surface area of the lithium titanate is 3.1 m²/g, 3.5 m²/g, 3.9 m²/g, 4.2 m²/g, 4.7 m²/g, 5.1 m²/g, 5.7 m²/g, 6.0 m²/g, 6.7 m²/g, 7.0 m²/g, 7.5 m²/g, 8.2 m²/g, or any value in a range defined by any two of the above values. Controlling the specific surface area of the lithium titanate within the above range allows the lithium titanate to have more active sites during the reaction process, and can increase the lithium intercalation and deintercalation capacity of the lithium titanate and reduce the solid-phase transmission impedance, improving the capacity and rate performance of the secondary battery.

In some embodiments of this application, a specific surface area of the lithium titanate is 4.2 m²/g to 7.0 m²/g. For example, the specific surface area of the lithium titanate is 4.2 m²/g, 4.7 m²/g, 5.1 m²/g, 5.7 m²/g, 6.0 m²/g, 6.7 m²/g, 7.0 m²/g, or any value in a range defined by any two of the above values. Controlling the specific surface area of the lithium titanate within the above range allows the lithium titanate to have more active sites during the reaction process, further improves the powder conductivity and lithium ion diffusion coefficient of the lithium titanate, and increases the lithium intercalation and deintercalation capacity of the negative electrode plate, thereby increasing the energy density of the secondary battery.

This application has no particular limitation on control methods of the particle sizes of the lithium titanate and the first active material, provided that the objectives of this application can be achieved. For example, the particle sizes of the lithium titanate and the first active material can be controlled by crushing and screening. This application has no particular limitation on a control method of the specific surface area of the lithium titanate, provided that the objectives of this application can be achieved. For example, the specific surface area of the lithium titanate can be controlled by controlling the particle sizes of the lithium titanate. Generally, larger particle sizes of the lithium titanate lead to a smaller specific surface area; and smaller particle sizes of the lithium titanate lead to a larger specific surface area.

In some embodiments of this application, a powder conductivity of the lithium titanate is 10⁻⁶ S/m to 10⁻⁴ S/m. Further, the powder conductivity of the lithium titanate is 4×10⁻⁵ S/m to 6×10⁻⁵ S/m. For example, the powder conductivity of the lithium titanate is 10⁻⁶ S/m, 7×10⁻⁶ S/m, 10⁻⁵ S/m, 4×10⁻⁵ S/m, 5×10⁻⁵ S/m, 6× 10 5 S/m, 8×10⁻⁵ S/m, 10 4 S/m, or any value in a range defined by any two of the above values. Controlling the powder conductivity of the lithium titanate within the above range is conducive to improving the rate performance, cycling stability, fast charging performance, and mechanical stability of the secondary battery, and also helps to improve the first-cycle coulombic efficiency.

This application has no particular limitation on a control method of the powder conductivity of the lithium titanate, provided that the objectives of this application can be achieved. For example, the powder conductivity of the lithium titanate can be controlled by purchasing the commercially available lithium titanate with the powder conductivity within the range of this application.

In some embodiments of this application, the negative electrode current collector includes any one of a copper current collector, a foamed copper current collector, a nickel current collector, or a stainless steel current collector. When the above types of negative electrode current collectors are applied to the negative electrode plate, the XY elongation of the negative electrode current collector can be alleviated, reducing the probability of purple spots at the head and tail of the negative electrode plate and electrolyte leakage caused by piercing of an outer package. When the prepared negative electrode plate is applied to the secondary battery, the energy density loss of the secondary battery can be alleviated, and the cycle life of the secondary battery can be extended. This is also conducive to alleviating the purple spots at the head and tail of the negative electrode plate, thereby allowing the secondary battery to have good kinetic performance.

This application has no particular limitation on a thickness of the negative electrode current collector, provided that the objectives of this application can be achieved. For example, the thickness of the negative electrode current collector is 6 μm to 10 μm. Optionally, the first material layer may further include at least one of a negative electrode conductive agent, a dispersant, or a negative electrode binder. The second material layer may further include at least one of a negative electrode conductive agent, a dispersant, or a negative electrode binder. This application has no particular limitation on the types of the negative electrode conductive agents, the dispersants, and the negative electrode binders in the first material layer and the second material layer, provided that the objectives of this application can be achieved. This application has no particular limitation on mass ratios of the negative electrode conductive agents, the dispersants, and the negative electrode binders in the first material layer and the second material layer, provided that the objectives of this application can be achieved. This application has no particular limitation on the amounts of the first active material and the second active material, provided that the objectives of this application can be achieved. For example, based on a mass of the negative electrode active material layer, a mass percentage of the lithium titanate is 1.5% to 2.5%, a mass percentage of the first active material is 5% to 20%, a mass percentage of the second silicon-containing material is 2% to 40%, a mass percentage of the carbon material is 35% to 90%, a mass percentage of the negative electrode conductive agent is 0.2% to 0.8%, a mass percentage of the dispersant is 0.3% to 1.7%, and a mass percentage of the negative electrode binder is 0.8% to 1.8%.

This application has no particular limitation on a preparation method of the negative electrode plate, provided that the objectives of this application can be achieved.

For example, in some embodiments of this application, the preparation method of the negative electrode plate includes but is not limited to the following steps: (1) preparing a first material layer slurry and a second material layer slurry; (2) uniformly applying the first material layer slurry on one surface of a negative electrode current collector, drying to form a first material layer, then uniformly applying the second material layer slurry on a surface of the first material layer away from the negative electrode current collector, drying to form a second material layer, to obtain a semi-finished negative electrode plate having one surface coated with a negative electrode active material layer; and (3) repeating step (2) on another surface of the negative electrode current collector to obtain a semi-finished negative electrode plate having two surfaces coated with negative electrode active material layers, followed by cold pressing and cutting to obtain the negative electrode plate. In some other embodiments of this application, after the above step (2), the semi-finished negative electrode plate can also be cold pressed and cut to obtain a negative electrode plate having one surface coated with a negative electrode active material layer.

According to a second aspect of this application, a secondary battery is provided and includes the negative electrode plate according to any one of the foregoing embodiments. Therefore, the secondary battery has good kinetic performance, a high energy density, and a long cycle life.

In some embodiments of this application, the secondary battery includes a positive electrode plate. This application has no particular limitation on the positive electrode plate, provided that the objectives of this application can be achieved. In an embodiment, the positive electrode plate includes a positive electrode current collector and a positive electrode active material layer. The positive electrode active material layer is disposed on one surface or two surfaces of the positive electrode current collector. The above “surface” may be a partial surface of the positive electrode current collector or an entire surface of the positive electrode current collector. This application has no particular limitation on the positive electrode current collector, provided that the objectives of this application can be achieved. For example, the positive electrode current collector may include aluminum foil or aluminum alloy foil. The positive electrode active material layer of this application includes a positive electrode active material. This application has no particular limitation on the type of the positive electrode active material, provided that the objectives of this application can be achieved. For example, the positive electrode active material may include at least one of lithium nickel cobalt manganese oxide, lithium nickel cobalt aluminum oxide, lithium iron phosphate, a lithium-rich manganese-based material, lithium cobaltate, lithium manganate, lithium manganese iron phosphate, or lithium titanate. In this application, the positive electrode active material may further include a non-metallic element. The non-metallic element may include at least one of fluorine, phosphorus, boron, chlorine, silicon, or sulfur. These elements can further improve the stability of the positive electrode active material. In this application, there is no particular limitation on thicknesses of the positive electrode current collector and the positive electrode active material layer, provided that the objectives of this application can be achieved. For example, the thickness of the positive electrode current collector is 5 μm to 20 μm. The thickness of a single positive electrode active material layer is 30 μm to 120 μm. Optionally, the positive electrode active material layer may further include at least one of a positive electrode conductive agent or a positive electrode binder. This application has no particular limitation on the types of the positive electrode conductive agent and the positive electrode binder in the positive electrode active material layer, provided that the objectives of this application can be achieved. This application has no particular limitation on a mass ratio of the positive electrode active material, the positive electrode conductive agent, and the positive electrode binder in the positive electrode active material layer. Those skilled in the art can select according to actual needs, provided that the objectives of this application can be achieved. For example, based on a mass of the positive electrode active material layer, a mass percentage of the positive electrode active material is 97.5% to 97.9%, a mass percentage of the positive electrode conductive agent is 0.8% to 1.7%, and a mass percentage of the positive electrode binder is 0.6% to 1.7%.

In some embodiments of this application, the secondary battery further includes a separator. The separator is disposed between the positive electrode plate and the negative electrode plate to separate the positive electrode plate and the negative electrode plate, prevent short circuit inside the secondary battery, and allow free passage of electrolyte ions without affecting the progress of the electrochemical charge-discharge process. This application has no particular limitation on the separator, provided that the objectives of this application can be achieved. For example, the material of the separator may include but is not limited to at least one of polyolefin (PO) mainly composed of polyethylene (PE) and polypropylene (PP), polyester (for example, a polyethylene terephthalate (PET) film), cellulose, polyimide (PI), polyamide (PA), spandex, or aramid. The type of the separator may include at least one of a woven film, a non-woven film, a microporous film, a composite film, a rolled film, or a spun film. This application has no particular limitation on a thickness of the separator, provided that the objectives of this application can be achieved.

In some embodiments of this application, the secondary battery further includes an electrolyte. This application has no particular limitation on the electrolyte, provided that the objectives of this application can be achieved. The secondary battery includes an outer package. The negative electrode plate, the positive electrode plate, the separator, and the electrolyte are accommodated in the outer package. This application has no particular limitation on the outer package, provided that the objectives of this application can be achieved.

The secondary battery of this application is not particularly limited and may include any apparatus that undergoes an electrochemical reaction. For example, the secondary battery may include but is not limited to: a lithium metal secondary battery, a lithium-ion secondary battery (lithium-ion battery), a lithium polymer secondary battery, or a lithium-ion polymer secondary battery.

This application has no particular limitation on a preparation method of the secondary battery. The preparation method known in the art can be selected, provided that the objectives of this application can be achieved. For example, the preparation method of the secondary battery includes but is not limited to the following steps: stacking the separator, the positive electrode plate, the separator, and the negative electrode plate in sequence, and performing operations such as winding and folding the resulting stack as needed to obtain an electrode assembly with a jelly-roll structure, placing the electrode assembly in the outer package, and injecting the electrolyte into the outer package and sealing, to obtain the secondary battery; or stacking the separator, the positive electrode plate, the separator, and the negative electrode plate in sequence, then fixing four corners of an entire laminated structure to obtain an electrode assembly with a laminated structure, placing the electrode assembly in the outer package, and injecting the electrolyte into the outer package and sealing, to obtain the secondary battery.

According to a third aspect of this application, an electronic apparatus is provided and includes the secondary battery according to any one of the foregoing embodiments. Therefore, the electronic apparatus has good use performance.

The electronic apparatus of this application is not particularly limited and may be any electronic apparatus known in the prior art. For example, the electronic apparatus may include but is not limited to: a notebook computer, a pen-input computer, a mobile computer, an e-book player, a portable phone, a portable facsimile machine, a portable copier, a portable printer, a head-mounted stereo headphone, a video recorder, a liquid crystal television, a portable cleaner, a portable CD player, a mini disc, a transceiver, an electronic notebook, a calculator, a storage card, a portable recorder, a radio, a backup power source, a motor, an automobile, a motorcycle, a power-assisted bicycle, a bicycle, a lighting fixture, a toy, a game console, a clock, an electric tool, a flashlight, a camera, a large household storage battery, and a lithium-ion capacitor.

### EXAMPLES

The following describes some embodiments of this application more specifically by using examples and comparative examples. Various tests and evaluations were carried out according to the following methods.

### Test Methods and Devices:

### Preparation of Negative Electrode Plate:

At 25° C., a lithium-ion battery discharged at a constant current of 0.2 C to a cutoff voltage of 3.0 V was disassembled. A negative electrode plate was taken and soaked in dimethyl carbonate (DMC) for 20 min, then rinsed once sequentially with DMC and acetone. Then, the negative electrode plate was placed in an oven and baked at 80° C. for 12 h to obtain a processed negative electrode plate sample. It can be understood that when a voltage range marked on a battery outer package is 3.0 V to 4.45 V, a charging cutoff voltage is 4.45 V, and a discharging cutoff voltage is 3.0 V. Unless otherwise specified, the lithium-ion battery used as an example in this application has a charging cutoff voltage of 4.45 V and a discharging cutoff voltage of 3.0 V.

Unless otherwise specified, the negative electrode plates used in the following test methods were obtained using the above method.

### Preparation of Lithium Titanate and First Active Material:

The negative electrode plate obtained by the foregoing method was used. A plasma polishing technology was used to start polishing from an upper layer of the negative electrode plate. After 90% of a total thickness of a negative electrode active material layer was polished and removed, the remaining material layer on a surface of a negative electrode current collector was a first material layer. After a substance of the remaining material layer was scraped from the negative electrode current collector, a differential centrifugation method was used to obtain lithium titanate and a first active material. The differential centrifugation method was a method to achieve separation by utilizing the difference in sedimentation velocities of different particles in a centrifugal field, where particles with higher density settled first, while particles with lower density required higher centrifugal force and longer time to settle. The specific steps were as follows: The substance of the first material layer was prepared into a suspension; under the action of gravity or centrifugal force, different substance particles settled; and according to sedimentation velocities of different substance particles, different substances in the first material layer were separated. A preparation method of the above suspension was as follows: 100 g of the substance of the first material layer was added to 1.0 L of deionized water; and under the ice bath condition, a homogenizer was used to break the substance of the first material layer to form a uniform suspension of 0.1 g/mL.

Elemental analysis was performed on the different substances obtained above, a substance containing the titanium element was lithium titanate, a substance containing the silicon element was a first active material, and a substance containing no silicon element and no titanium element was a carbon material.

Unless otherwise specified, the lithium titanate and the first active material used in the following test methods were obtained using the above method.

### Test of Particle Size:

With reference to the national standard GB/T 19077-2016 (Particle Size Distribution Laser Diffraction Method), a laser particle size analyzer (such as Malvern Master Size 3000) was used to measure particle sizes Dᵥ10, Dᵥ50, and Dᵥ90 of the lithium titanate and the first active material.

### Test of Thickness:

First, cross-sectional ion polishing treatment was performed on the negative electrode plate, then microscopic analysis was performed on the cross-section through a scanning electron microscope (SEM) to obtain a total thickness T₂ of a negative electrode active material layer. A first material layer was determined after titanium element analysis by an energy disperse spectroscopy (EDS), and then the single-layer thickness T₁ of the first material layer was obtained through SEM.

### Test of Percentage:

### (1) Test of Percentage W₂ of Silicon Element in First Active Material:

A plasma polishing technology was used to start polishing the negative electrode plate from the surface of the negative electrode plate. After 90% of the thickness of a negative electrode active material layer was polished and removed, the remaining part of the negative electrode active material layer is a first material layer. The remaining part was scraped from the surface of a negative electrode current collector. An inductively coupled plasma mass spectrometry (ICP-MS) was used to test, and a mass percentage A of the silicon element in the first material layer could be accurately tested. A test instrument used for the ICP-MS test was NexION 350X inductively coupled plasma mass spectrometer from PerkinElmer.

Calculation of coating weight: A sample with an area of 1 cm² was cut on the negative electrode plate. The sample was weighed on a balance, and the obtained weight was recorded as m1. Then, a second material layer on the sample was removed completely, the sample was weighed on the balance, and the obtained weight was recorded as m2. Then, the remaining first material layer was removed completely. A negative electrode current collector was weighed on the balance, and the obtained weight was recorded as m3.

For a negative electrode plate having one surface coated with a negative electrode active material layer, a coating weight CW of the negative electrode active material layer was equal to m1−m3, and a coating weight CW1 of a first material layer was equal to m2−m3.

For a negative electrode plate having two surfaces coated with negative electrode active material layers, a coating weight CW of the negative electrode active material layer was equal to (m1−m3)/2, and a coating weight CW1 of a first material layer was equal to (m2−m3)/2.

The mass percentage W₂ of the silicon element in the first active material was equal to A×CW1/CW.

Test of percentage W₃ of silicon element in negative electrode active material layer:

After a negative electrode active material layer was scraped from a negative electrode plate, inductively coupled plasma mass spectrometry (ICP-MS) test was performed to test a percentage of the silicon element in the negative electrode active material layer. A test instrument used for the ICP-MS test was NexION 350X inductively coupled plasma mass spectrometer from PerkinElmer.

### Test of Percentage of Lithium Titanate:

The test method in “test of percentage of silicon element in negative electrode active material layer” was used to test a percentage of the titanium element. The percentage of the lithium titanate was calculated according to the chemical formula Li₄Ti₅O₁₂ of the lithium titanate. The calculation basis of the percentage of the lithium titanate was the negative electrode active material layer.

### Test of Specific Surface Area of Lithium Titanate:

The lithium titanate obtained above was dried in a vacuum drying oven at 200° C. for 2 h. Then, with reference to the national standard Gas Adsorption BET Method for Determination of Specific Surface Area of Solid Substances (GB/T 19587-2017), a specific surface area analyzer (model: Tristar II 3020M) was used to test the specific surface area of the lithium titanate through a nitrogen adsorption method.

### Test of Powder Conductivity:

An FT-8100 series four-probe powder conductivity tester was used, a four-probe method measurement mode was adopted, and measurement of the powder conductivity of the lithium titanate could be performed. The specific steps were as follows:

The lithium titanate obtained above was dried in a vacuum drying oven at 200° C. for 2 h and then loaded into a sample tube. Then, measurement was performed using a four-probe powder conductivity tester to obtain the powder conductivity of the lithium titanate.

### Test of XY Elongation Rate of Negative Electrode Current Collector:

A lithium-ion battery was charged at a constant current of 1 C to 4.45 V in an environment at 25±3° C., then charged at a constant voltage of 4.45 V to 0.025 C, and then discharged at a constant current of 0.7 C to 3.0 V. This was one charge and discharge cycle. Test was performed according to the above charge and discharge cycle. After 200 cycles, the lithium-ion battery was charged at a constant current of 1 C to 4.45 V, then charged at a constant voltage of 4.45 V to 0.025 C, and then disassembled to take out a negative electrode plate. A copper foil width of an uncoated copper foil region was measured as σ₀. Copper foil widths of a front end (head), a middle end (middle), and a rear end (tail) of a region with a negative electrode active material layer were measured as σ₁, σ₂, and σ₃ respectively. It should be noted that in an unfolded state of the negative electrode plate obtained by disassembling, a side close to a winding center is the front end, a side far from the winding center is the rear end, and the middle end is located between the front end and the rear end. It can be understood that the winding center can be understood as a part clamped by a mandrel during a winding process of the lithium-ion battery.

Head XY elongation rate (%)=(σ₁−σ₀)/σ₀×100%.

Middle XY elongation rate (%)=(σ₂−σ₀)/σ₀×100%.

Tail XY elongation rate (%)=(σ₃−σ₀)/σ₀×100%.

XY elongation rate average (%)=(head elongation rate+middle elongation rate+tail elongation rate)/3.

Five lithium-ion batteries in each example and comparative example were taken for testing, and an average of test results of the five lithium-ion batteries was taken as an XY elongation level designed for the current lithium-ion battery.

### Determination of Purple Spots at Interface:

A lithium-ion battery was placed in a 25° C. thermostat and left standing for 60 min to make the lithium-ion battery reach a constant temperature. The lithium-ion battery that has reached the constant temperature was charged at a constant current of 1 C to 4.45 V at 25° C., then charged at a constant voltage of 4.45 V to 0.025 C, left standing for 5 min, and then discharged at a constant current of 1 C to 3.0 V. This was one charge and discharge cycle. After 200 charge and discharge cycles, the lithium-ion battery was charged at a constant current of 1 C to 4.45 V and then charged at a constant voltage of 4.45 V to 0.025 C, to obtain a fully charged battery after 200 cycles. The lithium-ion battery was disassembled in a dry room with a humidity less than 5%, and then photos were taken to record whether there were purple spots at a corner interface of the negative electrode plate. After taking photos, 3D MAX was used to measure an area of purple spots at the head and tail folds of the negative electrode plate and a total area of a negative electrode active material layer, and a percentage S of the area of the purple spots to the area of the negative electrode plate area was calculated. If S≤0.01%, “no purple spots” was recorded; if 0.01%<S≤0.5%, “slight purple spots” was recorded; if 0.5%<S≤1.5%, “moderate purple spots” was recorded; and if 1.5%<S, “severe purple spots” was recorded. It can be understood that the meaning of the above “head and tail folds” refers to the head or tail of the negative electrode plate in the lithium-ion battery with a jelly-roll structure was wound to form a part with two layers. It should be noted that the lithium-ion batteries of the examples and comparative examples of this application take the jelly-roll structure as an example, but this application is not limited thereto.

### Test of Energy Density:

First, dimensions of a lithium-ion battery were measured to obtain a thickness T, a width W, and a length L, and the volume V was calculated through the following formula: V=T×W×L.

Then, the lithium-ion battery was charged according to the following operation process, and then discharged to obtain a discharge capacity E of the lithium-ion battery:

Charging: The lithium-ion battery was charged at a constant current of 1 C to 4.45 V, and then charged at a constant voltage of 4.45 V to 0.025 C.

Discharging: The lithium-ion battery was discharged at a constant current of 0.2 C to 3.0 V to obtain the discharge energy E.

A volume energy density (VED) of the lithium-ion battery could be calculated by the following formula: VED (Wh/L)=E/V.

### Test of Cycle Life:

Five lithium-ion batteries in each example and comparative example were taken, charged at a constant current of 1 C to 4.45 V in an environment at 25±3° C., then charged at a constant voltage of 4.45 V to 0.025 C, and then discharged at a constant current of 0.7 C to 3.0 V. This was one charge and discharge cycle. Test was performed according to the above charge and discharge cycles. The number of cycles required for the lithium-ion battery capacity to decay to 80% of a first-cycle discharge capacity was used as the cycle life of the lithium-ion battery. An average of the five lithium-ion batteries was taken as a measurement value.

### Example 1-1

### <Preparation of Negative Electrode Plate>

Lithium titanate, a first active material silicon-carbon compound, a carbon material artificial graphite, a negative electrode binder polyacrylic acid, a negative electrode conductive agent single-walled carbon nanotubes, and a dispersant carboxymethyl cellulose were mixed well at a mass ratio of 5.7:22.8:64.4:5.4:0.3:1.4. Then, deionized water was added and stirred well to prepare a first material layer slurry with a solid content of 38 wt %.

A second active material including artificial graphite and a silicon-carbon compound (Dᵥ50=8.6 μm), a negative electrode binder polyacrylic acid, a negative electrode conductive agent single-walled carbon nanotubes, and a dispersant carboxymethyl cellulose were mixed well at a mass ratio of 77.6:19.4:2.4:0.2:0.4. Then, deionized water was added and stirred well to prepare a second material layer slurry with a solid content of 40 wt %.

The first material layer slurry was uniformly applied on a negative electrode current collector copper foil (copper current collector) and then dried at 85° C. to form a first material layer. The second material layer slurry was uniformly applied on a surface of the first material layer away from the copper foil and then dried at 85° C. to form a second material layer. Then, a semi-finished negative electrode plate having one surface coated with a negative electrode active material layer was obtained. The above steps were repeated on another surface of the copper foil to obtain a negative electrode plate having two surfaces coated with negative electrode active material layers, followed by cold pressing and cutting to obtain a negative electrode plate with specifications of 76 mm×856 mm for later use.

Based on a mass of the negative electrode active material layer, a mass percentage W₁ of the lithium titanate, a mass percentage W₂ of the silicon element in the first active material, and a mass percentage W₃ of the silicon element in the negative electrode active material layer were shown in Table 1. A particle size Dᵥ10 that was D₁₁, a particle size Dᵥ50 that was D₁₂, and a particle size Dᵥ90 that was D₁₃ of the lithium titanate, a specific surface area of the lithium titanate, a particle size Dᵥ10 that was D₂₁, a particle size Dᵥ50 that was D₂₂, a particle size Dᵥ90 that was D₂₃ of the first active material were shown in Table 2. A single-layer thickness T₁ of the first material layer and a total thickness T₂ of the negative electrode active material layer were shown in Table 4.

### <Preparation of Positive Electrode Plate>

A positive electrode active material lithium cobaltate, a positive electrode conductive agent conductive carbon black, and a positive electrode binder polyvinylidene fluoride (PVDF, with a weight-average molecular weight of 5×10⁵) were mixed at a mass ratio of 97.8:1.4:0.8, then N-methylpyrrolidone (NMP) was added as a solvent, and stirring was performed under the action of a vacuum mixer until a solid content was 75 wt % and the system was uniform to prepare a positive electrode slurry. The positive electrode slurry was uniformly applied on one surface of a positive electrode current collector aluminum foil with a thickness of 6 μm, followed by drying at 90° C. to obtain a positive electrode plate having one surface coated with a positive electrode active material layer (with a thickness of 80 μm). Then, the above steps were repeated on another surface of the aluminum foil to obtain a positive electrode plate having two surfaces coated with positive electrode active material layers, followed by cold pressing and cutting to obtain a positive electrode plate with specifications of 74 mm×851 mm for later use.

### <Preparation of Separator>

A polyethylene (PE) porous film with a thickness of 8 μm was used as a separator.

### <Preparation of Electrolyte>

In a dry argon atmosphere, organic solvents ethylene carbonate, methyl ethyl carbonate, and diethyl carbonate were mixed at a mass ratio of 30:50:20 to obtain a base electrolyte, then a lithium salt lithium hexafluorophosphate was added to the base electrolyte, and dissolved and mixed well to obtain an electrolyte with a lithium salt concentration of 1.15 mol/L.

### <Preparation of Lithium-Ion Battery>

The separator, positive electrode plate, separator, and negative electrode plate prepared above were stacked in sequence. The resulting stack was wound to obtain an electrode assembly. The electrode assembly was placed in an aluminum-plastic film outer package, followed by drying and electrolyte injection. Then, processes such as vacuum packaging, standing, formation, degassing, and trimming were performed to obtain a lithium-ion battery.

### Examples 1-2 to 1-4

These examples were the same as Example 1-1 except that the relevant preparation parameters were adjusted according to Table 1.

When the mass percentage W₁ of the lithium titanate changed, the mass percentage of the artificial graphite in the first material layer changed accordingly, and the mass percentage W₂ of the first active material and the mass percentages of the negative electrode binder, the negative electrode conductive agent, and the dispersant remained unchanged.

The mass percentage W₂ of the silicon element in the first active material was controlled by controlling the percentage of the first active material. When the mass percentage of the first active material changed, the mass percentage of the artificial graphite in the first material layer changed accordingly, and the mass percentage W₁ of the lithium titanate and the mass percentages of the negative electrode binder, the negative electrode conductive agent, and the dispersant remained unchanged. The mass percentages of the artificial graphite and the silicon-carbon compound in the second material layer changed accordingly to keep the mass percentage W₃ of the silicon element in the negative electrode active material layer unchanged.

### Examples 1-5 to 1-9

These examples were the same as Example 1-1 except that the relevant preparation parameters were adjusted according to Table 1.

In Examples 1-5 to 1-9, the mass percentage W₃ of the silicon element in the negative electrode active material layer was controlled by controlling the percentage of the second silicon-containing material in the second active material. When the mass percentage of the second silicon-containing material changed, the mass percentage of the artificial graphite in the second active material changed accordingly, and the mass percentages of the negative electrode binder, the negative electrode conductive agent, and the dispersant in the second material layer remained unchanged.

### Examples 2-1 to 2-15

These examples were the same as Example 1-2 except that the relevant preparation parameters were adjusted according to Table 2.

### Examples 3-1 to 3-8

These examples were the same as Example 1-2 except that the relevant preparation parameters were adjusted according to Table 4.

In Examples 3-1 to 3-4, when the single-layer thickness of the first material layer changed, the single-layer thickness of the second material layer changed accordingly to keep the total thickness of the negative electrode active material layer unchanged. When the single-layer thicknesses of the first material layer and the second material layer changed, the mass percentage W₁ of the lithium titanate, the mass percentage W₂ of the silicon element in the first active material, and the mass percentage W₃ of the silicon element in the negative electrode active material layer remained unchanged by controlling the mass percentages of the artificial graphite in the first material layer and the second material layer.

In Examples 3-5 to 3-8, when the total thickness of the negative electrode active material layer changed, the single-layer thickness of the first material layer remained unchanged, and the single-layer thickness of the second material layer changed accordingly. When the total thickness of the negative electrode active material layer changed, the mass percentage W₁ of the lithium titanate, the mass percentage W₂ of the silicon element in the first active material, and the mass percentage W₃ of the silicon element in the negative electrode active material layer remained unchanged by controlling the percentages of the lithium titanate, the first active material, and the artificial graphite in the first material layer and the percentages of the artificial graphite and the silicon-carbon compound in the second material layer.

### Example 4-1

This example was the same as Example 1-2 except that the relevant preparation parameters were adjusted according to Table 5.

### Comparative Examples 1 to 4

These comparative examples were the same as Example 1-1 except that the relevant preparation parameters were adjusted according to Table 1.

When the mass percentage W₁ of lithium titanate changed, the mass percentage of the artificial graphite in the first material layer changed accordingly, and the mass percentage W₂ of the first active material and the mass percentages of the negative electrode binder, the negative electrode conductive agent, and the dispersant remained unchanged.

The mass percentage W₂ of the silicon element in the first active material was controlled by controlling the percentage of the first active material. When the mass percentage of the first active material changed, the mass percentage of the artificial graphite in the first material layer changed accordingly, and the mass percentage W₁ of the lithium titanate and the mass percentages of the negative electrode binder, the negative electrode conductive agent, and the dispersant remained unchanged. The mass percentages of the artificial graphite and the silicon-carbon compound in the second material layer changed accordingly to keep the mass percentage W₃ of the silicon element in the negative electrode active material layer unchanged.

### Comparative Example 5

This comparative example was the same as Example 1-2 except that the negative electrode plate was prepared in the following steps.

### <Preparation of Negative Electrode Plate>

Artificial graphite and a silicon-carbon compound (Dᵥ50=8.6 μm), a negative electrode binder polyacrylic acid, a negative electrode conductive agent single-walled carbon nanotubes, and a dispersant carboxymethyl cellulose were mixed well at a mass ratio of 87.3:9.7:2.6:0.2:0.2. Then, deionized water was added and stirred well to prepare a negative electrode slurry with a solid content of 38 wt %.

The negative electrode slurry was uniformly applied on a negative electrode current collector copper foil and then dried at 85° C. to form a negative electrode active material layer. The above steps were repeated on another surface of the copper foil to obtain a negative electrode plate having two surfaces coated with negative electrode active material layers, followed by cold pressing and cutting to obtain a negative electrode plate with specifications of 76 mm×856 mm for later use. A total thickness of the negative electrode active material layer was 46 μm.

### Comparative Example 6

This comparative example was the same as Example 1-2 except that the negative electrode plate was prepared in the following steps.

### <Preparation of Negative Electrode Plate>

Lithium titanate, artificial graphite, a negative electrode binder polyacrylic acid, a negative electrode conductive agent single-walled carbon nanotubes, and a dispersant carboxymethyl cellulose were mixed well at a mass ratio of 8.1:83.2:5.7:2.8:0.2. Then, deionized water was added and stirred well to prepare a first material layer slurry with a solid content of 38 wt %.

A second active material including artificial graphite and a silicon-carbon compound (Dᵥ50=8.6 μm), a negative electrode binder polyacrylic acid, a negative electrode conductive agent single-walled carbon nanotubes, and a dispersant carboxymethyl cellulose were mixed well at a mass ratio of 67.3:20:9.7:2.8:0.2. Then, deionized water was added and stirred well to prepare a second material layer slurry with a solid content of 38 wt %.

The first material layer slurry was uniformly applied on a negative electrode current collector copper foil and then dried at 85° C. to form a first material layer. The second material layer slurry was uniformly applied on a surface of the first material layer away from the copper foil and then dried at 85° C. to form a second material layer. Then, a semi-finished negative electrode plate having one surface coated with a negative electrode active material layer was obtained. The above steps were repeated on another surface of the copper foil to obtain a negative electrode plate having two surfaces coated with negative electrode active material layers, followed by cold pressing and cutting to obtain a negative electrode plate with specifications of 76 mm×856 mm for later use.

Based on a mass of the negative electrode active material layer, a mass percentage W₁ of the lithium titanate and a mass percentage W₃ of the silicon element in the negative electrode active material layer were shown in Table 1. A particle size Dᵥ10 that was D₁₁, a particle size Dᵥ50 that was D₁₂, and a particle size Dᵥ90 that was

D₁₃ of the lithium titanate were the same as those in Example 1-1, and a specific surface area of the lithium titanate was the same as that in Example 1-1. A single-layer thickness T₁ of the first material layer, a single-layer thickness of the second material layer, and a total thickness T₂ of the negative electrode active material layer were the same as those in Example 1-1.

### Comparative Example 7

This comparative example was the same as Comparative Example 3 except that the relevant preparation parameters were adjusted according to Table 1.

The mass percentage W₂ of the silicon element in the first active material was controlled by controlling the percentage of the first active material. When the mass percentage of the first active material changed, the mass percentage of the artificial graphite in the first material layer changed accordingly, and the mass percentage W₁ of the lithium titanate and the mass percentages of the negative electrode binder, the negative electrode conductive agent, and the dispersant remained unchanged. The mass percentages of the artificial graphite and the silicon-carbon compound in the second material layer changed accordingly to keep the mass percentage W₃ of the silicon element in the negative electrode active material layer unchanged.

The preparation parameters and performance data of examples and comparative examples were shown in Tables 1 to 5.

TABLE 1

| | | | | Second | | | | | XY | | | |
|---|---|---|---|---|---|---|---|---|---|---|---|---|
| | | | | silicon- | | Head XY | Middle XY | Tail XY | elongation | Purple | Energy | Cycle |
| | W₁ | W₂ | | containing | W₃ | elongation | elongation | elongation | rate average | spot | density | life |
| | (%) | (%) | W₂/W₁ | material | (%) | rate (%) | rate (%) | rate (%) | (%) | situation | (Wh/L) | (cycles) |
| Example 1-1 | 1.50 | 6 | 4.0 | Silicon- | 16 | 0.35 | 0.32 | 0.35 | 0.34 | No purple | 799.1 | 737 |
| | | | | carbon | | | | | | spots | | |
| | | | | compound | | | | | | | | |
| Example 1-2 | 2.00 | 6 | 3.0 | Silicon- | 16 | 0.35 | 0.31 | 0.32 | 0.33 | No purple | 795.2 | 747 |
| | | | | carbon | | | | | | spots | | |
| | | | | compound | | | | | | | | |
| Example 1-3 | 2.50 | 6 | 2.4 | Silicon- | 16 | 0.31 | 0.27 | 0.30 | 0.29 | No purple | 789.2 | 758 |
| | | | | carbon | | | | | | spots | | |
| | | | | compound | | | | | | | | |
| Example 1-4 | 2.00 | 3 | 1.5 | Silicon- | 16 | 0.27 | 0.26 | 0.28 | 0.27 | No purple | 794.9 | 740 |
| | | | | carbon | | | | | | spots | | |
| | | | | compound | | | | | | | | |
| Example 1-5 | 2.00 | 6 | 3.0 | Silicon- | 2 | 0.26 | 0.25 | 0.26 | 0.26 | No purple | 727.2 | 852 |
| | | | | carbon | | | | | | spots | | |
| | | | | compound | | | | | | | | |
| Example 1-6 | 2.00 | 6 | 3.0 | Silicon- | 3.5 | 0.32 | 0.26 | 0.30 | 0.29 | No purple | 735.6 | 830 |
| | | | | carbon | | | | | | spots | | |
| | | | | compound | | | | | | | | |
| Example 1-7 | 2.00 | 6 | 3.0 | Silicon- | 30 | 0.41 | 0.40 | 0.46 | 0.42 | Slight | 873.1 | 722 |
| | | | | carbon | | | | | | purple | | |
| | | | | compound | | | | | | spots | | |
| Example 1-8 | 2.00 | 6 | 3.0 | Silicon- | 32 | 0.46 | 0.44 | 0.47 | 0.46 | Moderate | 884.2 | 701 |
| | | | | carbon | | | | | | purple | | |
| | | | | compound | | | | | | spots | | |
| Example 1-9 | 2.00 | 6 | 3.0 | Silicon- | 16 | 0.35 | 0.32 | 0.33 | 0.33 | No purple | 790.2 | 744 |
| | | | | oxygen | | | | | | spots | | |
| | | | | compound | | | | | | | | |
| Comparative | 0.50 | 6 | 12.0 | Silicon- | 16 | 0.65 | 0.64 | 0.66 | 0.65 | Severe | 804.1 | 699 |
| Example 1 | | | | carbon | | | | | | purple | | |
| | | | | compound | | | | | | spots | | |
| Comparative | 3.50 | 6 | 1.7 | Silicon- | 16 | 0.30 | 0.27 | 0.30 | 0.29 | No purple | 768.2 | 759 |
| Example 2 | | | | carbon | | | | | | spots | | |
| | | | | compound | | | | | | | | |
| Comparative | 2.00 | 2 | 1.0 | Silicon- | 16 | 0.27 | 0.26 | 0.27 | 0.27 | No purple | 773.4 | 710 |
| Example 3 | | | | carbon | | | | | | spots | | |
| | | | | compound | | | | | | | | |
| Comparative | 6.00 | 6 | 1.0 | Silicon- | 16 | 0.28 | 0.26 | 0.28 | 0.27 | No purple | 735.3 | 781 |
| Example 4 | | | | carbon | | | | | | spots | | |
| | | | | compound | | | | | | | | |
| Comparative | \ | \ | \ | Silicon- | 16 | 0.79 | 0.70 | 0.79 | 0.76 | Severe | 810.0 | 705 |
| Example 5 | | | | carbon | | | | | | purple | | |
| | | | | compound | | | | | | spots | | |
| Comparative | 2.00 | \ | \ | Silicon- | 10 | 0.25 | 0.24 | 0.25 | 0.25 | No purple | 705.0 | 740 |
| Example 6 | | | | carbon | | | | | | spots | | |
| | | | | compound | | | | | | | | |
| Comparative | 2.0 | 14 | 7.0 | Silicon- | 16 | 0.71 | 0.70 | 0.71 | 0.71 | Severe | 797.0 | 752 |
| Example 7 | | | | carbon | | | | | | purple | | |
| | | | | compound | | | | | | spots | | |

Note:
The “\” in Table 1 indicates no corresponding parameter.

From Examples 1-1 to 1-4 and Comparative Examples 1 to 7, it can be seen that in this application, the first material layer containing the lithium titanate and the first active material is disposed between the negative electrode current collector and the second material layer, and the mass percentage of the lithium titanate in the negative electrode active material layer and the ratio of the mass percentage of the lithium titanate in the negative electrode active material layer to the mass percentage of the silicon element in the first active material are controlled within the ranges of this application, so that the head, middle, and tail of the negative electrode current collector have small XY elongation rates, the purple spot situations at the head and tail of the negative electrode plate are slight, and the secondary battery has a high energy density and a long cycle life. This indicates that the secondary battery of this application can balance good kinetic performance, high energy density, and long cycle life. For the secondary batteries in the comparative examples, no first material layer is provided or the first material layer contains no first active material, the mass percentage of the lithium titanate in the negative electrode active material layer or the ratio of the mass percentage of the lithium titanate in the negative electrode active material layer to the mass percentage of the silicon element in the first active material are not within the ranges of this application, the head, middle, and tail of the negative electrode current collector have large XY elongation rates, the head and tail of the negative electrode plate have more severe purple spots, or the energy density of the secondary battery is low, or the cycle life of the secondary battery is short. This indicates that the secondary battery cannot balance the kinetic performance, energy density, and cycle life. As compared with Example 1-2, Comparative Example 2 and Comparative Example 4 have a significant decrease in energy density because the conductivity of the lithium titanate increases with the increase of the lithium intercalation amount. When the secondary battery is discharged to a low state of charge (SOC≤15%), the conductivity of the lithium titanate decreases significantly, affecting conductive networks of the silicon-containing material and the carbon materials at the end of discharge of the secondary battery, and leading to the failure of normal release of the capacity of the silicon-containing material and the carbon material. When the percentage of lithium titanate is excessively high (such as W₁>2.5%), the conductivity of the conductive networks of the silicon-containing material and the carbon material at the end of discharge of the secondary battery is extremely poor, reducing the energy density of the secondary battery. The reason why the cycle life does not decrease is that during the cycle life test of the secondary battery, discharge is performed at a large discharge rate of 0.7 C, the polarization during discharge (such as charge transfer polarization and concentration polarization) is large, and less lithium ions are deintercalated, causing no effect on the cycle life.

The mass percentage W₃ of the silicon element in the negative electrode active material layer usually affects the kinetic performance, energy density, and cycle life of the secondary battery. From Example 1-2 and Examples 1-5 to 1-8, it can be seen that the secondary battery using the mass percentage W₃ of the silicon element in the negative electrode active material layer within the range of this application has small XY elongation rates at the head, middle, and tail of the negative electrode current collector and slight purple spots at the head and tail of the negative electrode plate. The secondary battery has good kinetic performance, a high energy density, and a long cycle life

The type of the silicon-containing material usually affects the kinetic performance, energy density, and cycle life of the secondary battery. From Example 1-2 and Example 1-9, it can be seen that the secondary battery using the type of the silicon-containing material within the range of this application has small XY elongation rates at the head, middle, and tail of the negative electrode current collector and slight purple spots at the head and tail of the negative electrode plate. The secondary battery has good kinetic performance, a high energy density, and a long cycle life.

TABLE 2

| | | | | | | | | | | Specific | |
|---|---|---|---|---|---|---|---|---|---|---|---|
| | | | | | | | | | | surface | Powder |
| | | | | | | | | | | area of | conductivity |
| | | | | | | | | | | lithium | of lithium |
| | D₁₁ | D₁₂ | D₁₃ | D₂₁ | D₂₂ | D₂₃ | | | | titanate | titanate |
| | (μm) | (μm) | (μm) | (μm) | (μm) | (μm) | D₂₁/D₁₁ | D₂₂/D₁₂ | D₂₃/D₁₃ | (m²/g) | (S/m) |
| Example | 0.3 | 0.8 | 1.3 | 3.2 | 7.3 | 13 | 10.7 | 9.1 | 10.0 | 5.6 | 5.52 × 10⁻⁵ |
| 1-2 | | | | | | | | | | | |
| Example | 0.2 | 0.8 | 1.3 | 3.2 | 7.3 | 13 | 16.0 | 9.1 | 10.0 | 10.6 | 7.04 × 10⁻³ |
| 2-1 | | | | | | | | | | | |
| Example | 0.3 | 0.8 | 1.3 | 3.6 | 7.3 | 13 | 12.0 | 9.1 | 10.0 | 8.2 | 1.03 × 10⁻⁴ |
| 2-2 | | | | | | | | | | | |
| Example | 0.35 | 0.8 | 1.3 | 3.2 | 7.3 | 13 | 9.1 | 9.1 | 10.0 | 4 | 3.00 × 10⁻⁵ |
| 2-3 | | | | | | | | | | | |
| Example | 0.4 | 0.8 | 1.3 | 3.2 | 7.3 | 13 | 8.0 | 9.1 | 10.0 | 3.1 | 1.01 × 10⁻⁶ |
| 2-4 | | | | | | | | | | | |
| Example | 0.5 | 0.8 | 1.3 | 3.2 | 7.3 | 13 | 6.4 | 9.1 | 10.0 | 1.6 | 8.11 × 10⁻⁷ |
| 2-5 | | | | | | | | | | | |
| Example | 0.3 | 0.6 | 1.3 | 3.2 | 7.3 | 13 | 10.7 | 12.2 | 10.0 | 9.7 | 7.50 × 10⁻³ |
| 2-6 | | | | | | | | | | | |
| Example | 0.3 | 0.7 | 1.3 | 3.2 | 7.3 | 13 | 10.7 | 10.4 | 10.0 | 7.0 | 6.02 × 10⁻⁵ |
| 2-7 | | | | | | | | | | | |
| Example | 0.3 | 1 | 1.3 | 3.2 | 7.3 | 13 | 10.7 | 7.3 | 10.0 | 4.2 | 4.03 × 10⁻⁵ |
| 2-8 | | | | | | | | | | | |
| Example | 0.3 | 1.1 | 1.3 | 3.2 | 7.3 | 13 | 10.7 | 6.6 | 10.0 | 2.2 | 8.23 × 10⁻⁷ |
| 2-9 | | | | | | | | | | | |
| Example | 0.3 | 0.8 | 1.0 | 3.2 | 7.3 | 13 | 10.7 | 9.1 | 13.0 | 8.6 | 6.70 × 10⁻³ |
| 2-10 | | | | | | | | | | | |
| Example | 0.3 | 0.8 | 1.1 | 3.2 | 7.3 | 13 | 10.7 | 9.1 | 11.8 | 7.2 | 6.40 × 10⁻⁵ |
| 2-11 | | | | | | | | | | | |
| Example | 0.3 | 0.8 | 1.3 | 3.2 | 7.3 | 16.8 | 10.7 | 9.1 | 12.9 | 5.6 | 5.52 × 10⁻⁵ |
| 2-12 | | | | | | | | | | | |
| Example | 0.3 | 0.8 | 1.3 | 3.2 | 7.3 | 11.2 | 10.7 | 9.1 | 8.6 | 5.6 | 5.52 × 10⁻⁵ |
| 2-13 | | | | | | | | | | | |
| Example | 0.3 | 0.8 | 1.5 | 3.2 | 7.3 | 13 | 10.7 | 9.1 | 8.7 | 4.4 | 4.05 × 10⁻⁵ |
| 2-14 | | | | | | | | | | | |
| Example | 0.3 | 0.8 | 1.8 | 3.2 | 7.3 | 13 | 10.7 | 9.1 | 7.2 | 2.8 | 9.81 × 10⁻⁷ |
| 2-15 | | | | | | | | | | | |

TABLE 3

| | | | | XY | | | |
|---|---|---|---|---|---|---|---|
| | | Middle | | elongation | | | |
| | Head XY | XY | Tail XY | rate | Purple | Energy | |
| | elongation | elongation | elongation | average | spot | density | Cycle life |
| | rate (%) | rate (%) | rate (%) | (%) | situation | (Wh/L) | (cycles) |
| Example 1-2 | 0.35 | 0.31 | 0.32 | 0.33 | No purple | 795.2 | 747 |
| | | | | | spots | | |
| Example 2-1 | 0.38 | 0.35 | 0.39 | 0.37 | Slight | 799.1 | 742 |
| | | | | | purple | | |
| | | | | | spots | | |
| Example 2-2 | 0.34 | 0.31 | 0.32 | 0.32 | No purple | 794.3 | 744 |
| | | | | | spots | | |
| Example 2-3 | 0.33 | 0.31 | 0.33 | 0.32 | No purple | 794.0 | 750 |
| | | | | | spots | | |
| Example 2-4 | 0.33 | 0.30 | 0.33 | 0.32 | No purple | 793.2 | 752 |
| | | | | | spots | | |
| Example 2-5 | 0.32 | 0.29 | 0.32 | 0.31 | No purple | 792.0 | 757 |
| | | | | | spots | | |
| Example 2-6 | 0.36 | 0.34 | 0.35 | 0.35 | Slight | 797.8 | 744 |
| | | | | | purple | | |
| | | | | | spots | | |
| Example 2-7 | 0.34 | 0.32 | 0.35 | 0.34 | No purple | 796.3 | 745 |
| | | | | | spots | | |
| Example 2-8 | 0.30 | 0.29 | 0.32 | 0.30 | No purple | 793.6 | 751 |
| | | | | | spots | | |
| Example 2-9 | 0.30 | 0.27 | 0.30 | 0.29 | No purple | 793.0 | 753 |
| | | | | | spots | | |
| Example 2- | 0.35 | 0.34 | 0.35 | 0.35 | Slight | 797.5 | 744 |
| 10 | | | | | purple | | |
| | | | | | spots | | |
| Example 2- | 0.35 | 0.31 | 0.35 | 0.34 | No purple | 796.6 | 745 |
| 11 | | | | | spots | | |
| Example 2- | 0.33 | 0.30 | 0.32 | 0.32 | No purple | 793.4 | 752 |
| 12 | | | | | spots | | |
| Example 2- | 0.35 | 0.32 | 0.34 | 0.34 | No purple | 796.4 | 745 |
| 13 | | | | | spots | | |
| Example 2- | 0.33 | 0.31 | 0.32 | 0.32 | No purple | 794.1 | 750 |
| 14 | | | | | spots | | |
| Example 2- | 0.30 | 0.29 | 0.30 | 0.30 | No purple | 792.9 | 753 |
| 15 | | | | | spots | | |

The particle size Dᵥ10, particle size Dᵥ50, and particle size Dᵥ90 of lithium titanate usually affect the kinetic performance, energy density, and cycle life of the secondary battery. From Example 1-2, Example 2-1, Examples 2-3 to 2-11, Example 2-14, and Example 2-15, it can be seen that when the particle size Dᵥ10, particle size Dᵥ50, and particle size Dᵥ90 of the lithium titanate are within the ranges of this application, the specific surface area and powder conductivity of lithium titanate are also within the ranges of this application. The secondary battery using the particle size Dᵥ10, particle size Dᵥ50, particle size Dᵥ90 of the lithium titanate as well as the specific surface area and powder conductivity of the lithium titanate within the ranges of this application has small XY elongation rates at the head, middle, and tail of the negative electrode current collector and slight purple spots at the head and tail of the negative electrode plate. The secondary battery has good kinetic performance, a high energy density, and a long cycle life.

The values of the relationships D₂₁/D₁₁, D₂₂/D₁₂, and D₂₃/D₁₃ between the particle sizes of the lithium titanate and the particle sizes of the first active material usually affect the kinetic performance, energy density, and cycle life of the secondary battery. From Example 1-2 and Examples 2-1 to 2-15, it can be seen that the secondary battery using the values of D₂₁/D₁₁, D₂₂/D₁₂, and D₂₃/D₁₃ within the ranges of this application has small XY elongation rates at the head, middle, and tail of the negative electrode current collector and slight purple spots at the head and tail of the negative electrode plate. The secondary battery has good kinetic performance, a high energy density, and a long cycle life.

TABLE 4

| | | Total thickness | | | | | XY | | | |
|---|---|---|---|---|---|---|---|---|---|---|
| | Thickness | T₂ of negative | | | | | elongation | | | |
| | T₁ of first | electrode | T₁/T₂ × | Head XY | Middle XY | Tail XY | rate | Purple | Energy | |
| | material | active material | 100% | elongation | elongation | elongation | average | spot | density | Cycle life |
| | layer (μm) | layer (μm) | (%) | rate (%) | rate (%) | rate (%) | (%) | situation | (Wh/L) | (cycles) |
| Example 1-2 | 11 | 46 | 23.9 | 0.35 | 0.31 | 0.32 | 0.33 | No purple | 795.2 | 747 |
| | | | | | | | | spots | | |
| Example 3-1 | 8 | 46 | 17.4 | 0.30 | 0.26 | 0.28 | 0.28 | No purple | 782.5 | 751 |
| | | | | | | | | spots | | |
| Example 3-2 | 10 | 46 | 21.7 | 0.32 | 0.31 | 0.32 | 0.32 | No purple | 794.2 | 750 |
| | | | | | | | | spots | | |
| Example 3-3 | 12 | 46 | 26.1 | 0.35 | 0.32 | 0.34 | 0.34 | No purple | 797.2 | 744 |
| | | | | | | | | spots | | |
| Example 3-4 | 14 | 46 | 30.4 | 0.38 | 0.34 | 0.39 | 0.37 | Slight | 799.4 | 738 |
| | | | | | | | | purple | | |
| | | | | | | | | spots | | |
| Example 3-5 | 11 | 101 | 10.9 | 0.26 | 0.24 | 0.26 | 0.25 | No purple | 824.4 | 735.2 |
| | | | | | | | | spots | | |
| Example 3-6 | 11 | 91 | 12.1 | 0.27 | 0.26 | 0.27 | 0.27 | No purple | 815.4 | 738.4 |
| | | | | | | | | spots | | |
| Example 3-7 | 11 | 30 | 36.7 | 0.34 | 0.33 | 0.35 | 0.34 | No purple | 785.0 | 758.2 |
| | | | | | | | | spots | | |
| Example 3-8 | 11 | 26 | 42.3 | 0.48 | 0.45 | 0.48 | 0.47 | Moderate | 775.0 | 759.5 |
| | | | | | | | | purple | | |
| | | | | | | | | spots | | |

The single-layer thickness T₁ of the first material layer usually affects the kinetic performance, energy density, and cycle life of the secondary battery. From Example 1-2 and Examples 3-1 to 3-4, it can be seen that the secondary battery using the single-layer thickness T₁ of the first material layer within the range of this application has small XY elongation rates at the head, middle, and tail of the negative electrode current collector and slight purple spots at the head and tail of the negative electrode plate. The secondary battery has good kinetic performance, a high energy density, and a long cycle life. When the mass percentage W₁ of the lithium titanate, the mass percentage W₂ of the silicon element in the first active material, and the mass percentage W₃ of the silicon element in the negative electrode active material layer remain unchanged, and the total thickness of the negative electrode active material layer remains unchanged, the first material layer becomes thicker, which means that the percentages of LTO and Si in a “lower layer (the first material layer)” decrease, the LTO in the lower layer is more dispersed, the alleviating effect on the expansion of silicon in the lower layer is weakened, and the XY elongation becomes worse. The effect of “filling gaps” of LTO becomes better, the compaction density of the negative electrode plate increases, and the energy density of the secondary battery increases. However, the effect of dispersed LTO on improving a silicon conductive network becomes worse, so the cycle life of the secondary battery becomes shorter.

The value of the relationship T₁/T₂×100% between the single-layer thickness T₁ of the first material layer and the total thickness T₂ of the negative electrode active material layer usually affects the kinetic performance, energy density, and cycle life of the secondary battery. From Example 1-2 and Examples 3-1 to 3-8, it can be seen that the secondary battery using the value of the relationship T₁/T₂×100% between the single-layer thickness T₁ of the first material layer and the total thickness T₂ of the negative electrode active material layer within the range of this application has small XY elongation rates at the head, middle, and tail of the negative electrode current collector and slight purple spots at the head and tail of the negative electrode plate. The secondary battery has good kinetic performance, a high energy density, and a long cycle life. When the mass percentage W₁ of the lithium titanate, the mass percentage W₂ of the silicon element in the first active material, and the mass percentage W₃ of the silicon element in the negative electrode active material layer remain unchanged, the total thickness of the negative electrode active material layer increases, the thickness of an upper layer (the second material layer) increases, the thickness of the lower layer (the first material layer) remains unchanged, LTO in the lower layer becomes more concentrated, the alleviating effect on the expansion of silicon in the lower layer is enhanced, and the XY elongation is alleviated. The effect of “filling gaps” of LTO becomes worse, the compaction density of the negative electrode plate decreases, and the energy density of the secondary battery decreases. However, because the total thickness of the negative electrode active material layer increases, the energy density of the secondary battery generally increases. The effect of more concentrated LTO on improving the silicon conductive network becomes better. However, from the perspective of the entire negative electrode plate, the absolute amount of silicon in the upper layer is excessively high, leading to a shorter cycle life of the secondary battery.

TABLE 5

| | | | | | XY | | | |
|---|---|---|---|---|---|---|---|---|
| | Negative | | Middle | | elongation | | | |
| | electrode | Head XY | XY | Tail XY | rate | Purple | Energy | |
| | current | elongation | elongation | elongation | average | spot | density | Cycle life |
| | collector | rate (%) | rate (%) | rate (%) | (%) | situation | (Wh/L) | (cycles) |
| Example 1-2 | Copper | 0.35 | 0.31 | 0.32 | 0.33 | No | 795.2 | 747 |
| | current | | | | | purple | | |
| | collector | | | | | spots | | |
| Example 4-1 | Nickel | 0.29 | 0.26 | 0.30 | 0.28 | No | 794.2 | 748 |
| | current | | | | | purple | | |
| | collector | | | | | spots | | |

The type of negative electrode current collector usually affects the kinetic performance, energy density, and cycle life of the secondary battery. From Example 1-2 and Example 4-1, it can be seen that the secondary battery using the type of negative electrode current collector within the range of this application has small XY elongation rates at the head, middle, and tail of the negative electrode current collector and slight purple spots at the head and tail of the negative electrode plate. The secondary battery has good kinetic performance, a high energy density, and a long cycle life.

It should be noted that, in this context, relational terms such as “first” and “second” are used merely to distinguish one entity or operation from another entity or operation, and do not necessarily require or imply any such actual relationship or sequence between these entities or operations. Moreover, the terms “include”, “comprise”, or any other variant thereof are intended to cover non-exclusive inclusion, such that a process, method, article, or apparatus that includes a series of elements not only includes those elements but also includes other elements not explicitly listed or inherent to such process, method, article, or apparatus.

The various embodiments in this specification are described in a related manner, and identical or similar parts between the various embodiments can be referred to each other, with each embodiment focusing on differences from other embodiments.

The above descriptions are merely preferred embodiments of this application and are not intended to limit this application. Any modification, equivalent substitution, improvement, and the like made within the spirit and principle of this application shall fall within the protection scope of this application.

What is claimed is:

1. A negative electrode plate, comprising a negative electrode current collector and a negative electrode active material layer disposed on at least one surface of the negative electrode current collector, wherein the negative electrode active material layer comprises a first material layer and a second material layer, the first material layer is disposed between the negative electrode current collector and the second material layer, and the second material layer contains silicon element;
the first material layer comprises lithium titanate and a first active material, and the first active material comprises a first silicon-containing material; and
based on a mass of the negative electrode active material layer, a mass percentage of the lithium titanate is W₁, and 1.5%≤W₁≤2.5%;
based on the mass of the negative electrode active material layer, a mass percentage of the silicon element in the first active material is W₂, and 1.5≤W₂/W₁≤4.0.

2. The negative electrode plate according to claim 1, wherein the lithium titanate has a particle size Dᵥ10 of D₁₁, a particle size Dᵥ50 of D₁₂, and a particle size Dᵥ90 of D₁₃, wherein 0.3 μm≤D₁₁≤0.4 μm, 0.7 μm≤D₁₂≤1.0 μm, and 1.1 μm≤D₁₃≤1.5 μm.

3. The negative electrode plate according to claim 2, wherein the first active material has a particle size Dᵥ10 of D₂₁, a particle size Dᵥ50 of D₂₂, and a particle size Dᵥ90 of D₂₃; and the particle sizes of the lithium titanate and the particle sizes of the first active material satisfy: 8.0≤D₂₁/D₁₁≤12.0, 7.3≤D₂₂/D₁₂≤10.4, and 8.6≤D₂₃/D₁₃≤11.8.

4. The negative electrode plate according to claim 1, wherein a single-layer thickness of the first material layer is T₁, and 10 μm≤T_{1≤12} μm.

5. The negative electrode plate according to claim 4, wherein a total thickness of the negative electrode active material layer is T₂, and 12%≤T₁/T₂×100%≤37%.

6. The negative electrode plate according to claim 1, wherein the negative electrode plate satisfies at least one of the following features:
(1) based on the mass of the negative electrode active material layer, a mass percentage of the silicon element in the negative electrode active material layer is W₃, and 3.5%≤W₃≤30%; or
(2) 2.4≤W₂/W₁≤4.0.

7. The negative electrode plate according to claim 1, wherein a specific surface area of the lithium titanate is 3.1 m²/g to 8.2 m²/g.

8. The negative electrode plate according to claim 1, wherein a powder conductivity of the lithium titanate is 10⁻⁶ S/m to 10⁻⁴ S/m.

9. The negative electrode plate according to claim 1, wherein the lithium titanate satisfies at least one of the following features:
(1) a specific surface area of the lithium titanate is 4.2 m²/g to 7.0 m²/g; or
(2) a powder conductivity of the lithium titanate is 4×10⁻⁵ S/m to 6×10⁻⁵ S/m.

10. The negative electrode plate according to claim 1, wherein the second material layer comprises a second active material, the second active material comprises a second silicon-containing material; and the second silicon-containing material comprises at least one of a silicon-carbon compound, a silicon-oxygen compound, or pure silicon.

11. The negative electrode plate according to claim 10, wherein the second active material comprises a second carbon material; the second carbon material comprises at least one of artificial graphite, natural graphite, hard carbon, soft carbon, or mesophase carbon microspheres.

12. The negative electrode plate according to claim 1, wherein the first active material comprises a first carbon material; the first carbon material comprises at least one of artificial graphite, natural graphite, hard carbon, soft carbon, or mesophase carbon microspheres.

13. The negative electrode plate according to claim 1, wherein the negative electrode current collector comprises one of a copper current collector, a foamed copper current collector, a nickel current collector, or a stainless steel current collector.

14. A secondary battery, wherein the secondary battery comprises the negative electrode plate according to claim 1.

15. An electronic apparatus, wherein the electronic apparatus comprises the secondary battery according to claim 14.

16. The electronic apparatus according to claim 15, wherein the lithium titanate has a particle size Dᵥ10 of D₁₁, a particle size Dᵥ50 of D₁₂, and a particle size Dᵥ90 of D₁₃, wherein 0.3 μm≤D₁₁≤0.4 μm, 0.7 μm≤D₁₂≤1.0 μm, and 1.1 μm≤D₁₃≤1.5 μm.

17. The electronic apparatus according to claim 15, wherein a single-layer thickness of the first material layer is T₁, and 10 μm≤T₁≤12 μm.

18. The electronic apparatus according to claim 17, wherein a total thickness of the negative electrode active material layer is T₂, and 12%≤T₁/T₂×100%≤37%.

19. The electronic apparatus according to claim 15, wherein the negative electrode plate satisfies at least one of the following features:
(1) based on the mass of the negative electrode active material layer, a mass percentage of the silicon element in the negative electrode active material layer is W₃, and 3.5%≤W₃≤30%; or
(2) 2.4≤W₂/W₁≤4.0.

20. The electronic apparatus according to claim 15, wherein the lithium titanate satisfies at least one of the following features:
(1) a specific surface area of the lithium titanate is 4.2 m²/g to 7.0 m²/g; or
(2) a powder conductivity of the lithium titanate is 4×10⁻⁵ S/m to 6×10⁻⁵ S/m.
